(19) United States
(12) Patent Application Publication
(10) Pub. No.: US 2021/0032720 A1
(43) Pub. Date: Feb. 4, 2021

(54) METHOD OF HEATING STEEL SHEET IN CONTINUOUS ANNEALING AND CONTINUOUS ANNEALING FACILITY

(71) Applicant: JFE STEEL CORPORATION, Tokyo (JP)

(72) Inventor: Tetsuro NISHIDA, Tokyo (JP)

(73) Assignee: JFE STEEL CORPORATION, Tokyo (JP)

(21) Appl. No.: 16/967,312

(22) PCT Filed: Feb. 19, 2019
(86) PCT No.: PCT/JP2019/006031

§ 371 Date: Aug. 4, 2020

(30) Foreign Application Priority Data
Feb. 22, 2018 (JP) 2018-029490

(51) Int. Cl. C21D 11/00; C21D 9/56

(52) U.S. Cl. CPC C21D 11/00; C21D 9/56

(57) ABSTRACT

A method of heating a steel sheet and a continuous annealing facility therefor wherein the temperature of the steel sheet in the longitudinal direction and sheet width direction is uniformized and overheating of the steel sheet exceeding the soaking temperature as the target heating temperature is prevented. ΔT is a value of not less than a variation range of the steel sheet temperature when the sheet temperature is controlled by feedback control in the heating furnace but not more than ½ of a heating capacity of the steel sheet in the semi-soaking furnace.

### TECHNICAL FIELD

This invention relates to a method of continuous annealing of a steel sheet, and more particularly to a method of heating a steel sheet suitable for use in continuous annealing of a hot-rolled steel sheet and a cold-rolled steel sheet, and a continuous annealing facility used in this method.

### BACKGROUND ART

A method of applying a heat treatment to a steel sheet that has been subjected to hot rolling (hot-rolled steel sheet) or a steel sheet that has been subjected to cold rolling (cold-rolled steel sheet) includes a batch annealing using a box annealing furnace and a continuous annealing conducted by threading the steel sheet into an annealing furnace while rewinding the steel sheet coil to continuously conduct a heat treatment. In recent years, the latter continuous annealing being excellent in productivity has been frequently used. The continuous annealing has merits that the treatment temperature for the steel sheet can be uniformized and the treatment time can be shortened as compared to the batch annealing. On the other hand, it is necessary to conduct rapid heating, increase the annealing temperature (soaking temperature) or the like in association with the shortening of the treatment time, resulting a problem that the temperature of the steel sheet is easily non-uniformized in the longitudinal direction or the sheet width direction of the coil.

As a method of uniformizing the treatment temperature of the steel sheet in the continuous annealing, for example, Patent Literature 1 discloses a method of continuously conducting a heat treatment by joining the leading end in the hot rolling direction of a preceding steel strip to the leading end in the hot rolling direction of the following steel strip or joining the rear end in the hot rolling direction of the preceding steel strip to the rear end in the hot rolling direction of the following steel sheet. However, the method disclosed in Patent Literature 1 is a technique of indirectly uniformizing the heat treatment temperature in the longitudinal direction of the coil but is not a technique of directly uniformizing the temperature of the steel sheet. For the execution of this method, it is necessary to rewind half number of the coil, causing a problem that the productivity is considerably impeded.

Patent Literature 2 discloses a method of controlling a sheet temperature in a continuous annealing process where the steel sheet is preheated in a preheating furnace disposed in an upstream side of an annealing furnace used in the continuous annealing of the steel sheet and the flow rate of a fuel supplied to a heating device in the furnace is controlled based on a sheet temperature measured at an exit side of the preheating furnace and at an entry side of the annealing furnace to perform sheet temperature feedforward control for maintaining the sheet temperature at an annealing temperature.

### CITATION LIST

### Patent Literature

Patent Literature 1: JP-A-2005-232482

Patent Literature 2: JP-A-2004-197144

### SUMMARY OF INVENTION

### Technical Problem

In recent years, the demand for quality property of the final product tends to become stricter year by year in the field of hot-rolled steel sheets and cold-rolled steel sheets. In order to satisfy the demand, the heat treatment temperature for the steel sheet is controlled very strictly. For example, it has been found that not only the temperature in the longitudinal direction of the steel sheet coil needs to be uniformized but also the temperature distribution in the sheet width direction of the steel sheet needs to be uniformized within a given range or overheating of the steel sheet exceeding the predetermined temperature needs to be prevented.

In the method disclosed in Patent Literature 2, the flow rate of the fuel supplied to the annealing furnace is controlled based on the sheet temperature measured at the exit side of the preheating furnace to control the sheet temperature in the annealing furnace. However, it is not a technique of also controlling the sheet temperature at the exit side of the preheating furnace. Therefore, there is a problem that when a large temperature non-uniformity or overheating is caused in the steel sheet at the exit side of the preheating furnace, it is difficult to control the steel sheet temperature to a given range in the annealing furnace.

The invention is made in view of the above problems inherent to the prior arts, and an object thereof is to propose a heating method of the steel sheet capable of uniformizing the steel sheet temperature in the longitudinal direction and the sheet width direction in the continuous annealing and surely preventing overheating of the steel sheet exceeding a soaking temperature as a target heating temperature and to provide a continuous annealing facility therefor.

### Solution to Problem

The inventors have made various studies to solve the above task, and as a result, they found the following. That is, in a continuous annealing facility of a steel sheet having a direct heating furnace, a soaking furnace and a cooling furnace, a direct semi-soaking furnace is disposed between the heating furnace and the soaking furnace, and, in the heating furnace, the steel sheet temperature at the exit side of the heating furnace (hereinafter abbreviated as “sheet temperature”) is heated to a temperature lower than the soaking temperature as a target heating temperature (hereinafter referred to as “target soaking temperature”) by ΔT, while, in the semi-soaking furnace, the furnace temperature is set to the target soaking temperature and the ΔT is controlled to a proper range, whereby the above object can be achieved by performing slow heating so that the sheet temperature will reach the target soaking temperature at a position in the semi-soaking furnace, and as a result, the invention has been accomplished.

That is, the invention proposes a method of heating a steel sheet in a continuous annealing facility comprising a direct heating furnace, a soaking furnace and a cooling furnace, characterized in that a direct semi-soaking furnace is disposed between the heating furnace and the soaking furnace; the steel sheet is heated in the heating furnace so that the steel sheet temperature at an exit side of the heating furnace reaches (a target soaking temperature-ΔT); and the furnace temperature in the semi-soaking furnace is set to the target soaking temperature of the steel sheet and the steel sheet is heated so that the temperature thereof reaches the target soaking temperature at a position in the semi-soaking furnace. Here, ΔT is a value of not less than the variation range of the steel sheet temperature when the sheet temperature is controlled by feedback control in the heating furnace, and is a value of not more than ½ of the heating capacity for the steel sheet in the semi-soaking furnace.

The method of heating the steel sheet according to the invention is characterized in that the value of ΔT is made large when a flow rate of a fuel supplied to a direct burner in the semi-soaking furnace reaches the lower limit of a fuel supply capacity in the semi-soaking furnace, while the value of ΔT is made small when it reaches the upper limit of the fuel supply capacity in the semi-soaking furnace.

The method of heating the steel sheet according to the invention is also characterized in that the flow rate of the fuel supplied to the direct burner in the semi-soaking furnace falls within the range from the lower limit of the fuel supply capacity×1.2 to the upper limit of the fuel supply capacity×0.8 in the semi-soaking furnace.

The invention further provides a continuous annealing facility for a steel sheet comprising a direct heating furnace, a soaking furnace and a cooling furnace, characterized in that a direct semi-soaking furnace is disposed between the heating furnace and the soaking furnace; the steel sheet is heated in the heating furnace so that a steel sheet temperature at an exit side of the heating furnace reaches (a target soaking temperature-ΔT); and the furnace temperature in the semi-soaking furnace is set to the target soaking temperature of the steel sheet and the steel sheet is heated so that the temperature thereof reaches the target soaking temperature at a position of the semi-soaking furnace. Here, ΔT is a value of not less than the variation range of the steel sheet temperature when the sheet temperature is controlled by feedback control in the heating furnace, and is also a value of not more than ½ of the heating capacity for the steel sheet in the semi-soaking furnace.

### Advantageous Effects of Invention

According to the invention, the direct semi-soaking furnace is disposed between the direct heating furnace and the soaking furnace, and a slow heating is conducted in the semi-soaking furnace just before the steel sheet temperature reaches the target soaking temperature, so that the steel sheet temperature easily converges into the target soaking temperature, and not only the sheet temperature can be uniformized in the longitudinal direction and sheet width direction of the steel sheet, but also the overheating of the steel sheet exceeding the target soaking temperature can be surely prevented. According to the invention, therefore, the heat treatment temperature of the steel sheet can be controlled with much higher precision, which largely contributes to an improvement and stabilization of the product quality.

### BRIEF DESCRIPTION OF DRAWINGS

FIG. 1 is a diagram illustrating a method of controlling a steel sheet temperature in a continuous annealing facility.

FIG. 2 is a graph showing an example of a change of a general heat transfer coefficient ∅_{CG} with a lapse of time in a continuous annealing.

FIG. 3 is a diagram illustrating a method of controlling a steel sheet temperature provided by adding feedback control to the method shown in FIG. 1.

FIG. 4 is a diagram illustrating a method of controlling a steel sheet temperature in a continuous annealing facility provided with a semi-soaking furnace according to the invention.

FIG. 5 is a graph comparatively showing a change of a sheet temperature with a lapse of time measured at an exit side of a semi-soaking furnace, comparing the case with and without an operation of the semi-soaking furnace according to the invention.

FIG. 6 is a graph comparatively showing a temperature variation in the longitudinal direction of a steel sheet (3σ) and a temperature difference in the sheet width direction thereof, comparing the case with or without an operation of the semi-soaking furnace according to the invention.

### DESCRIPTION OF EMBODIMENTS

An embodiment of the invention will be described below with the drawings.

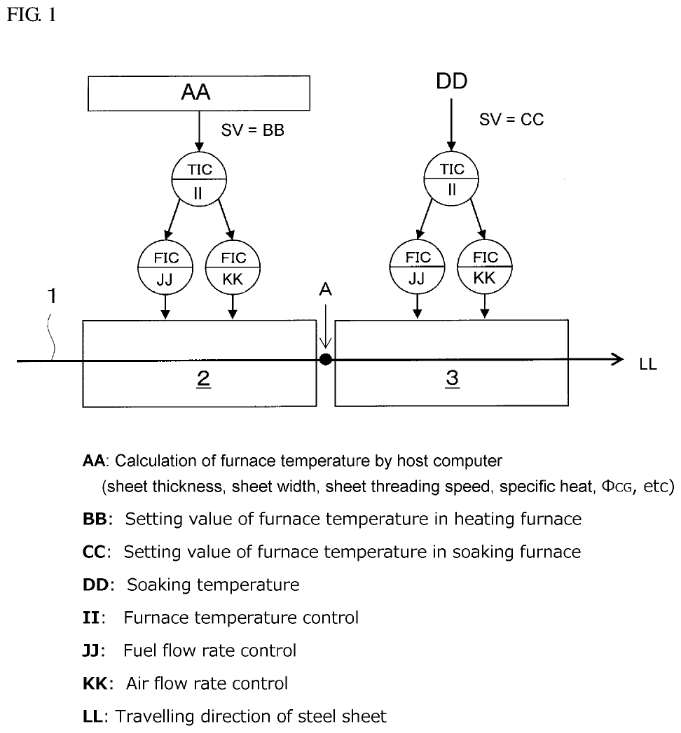

FIG. 1 shows a method of controlling a steel sheet temperature (sheet temperature) in a heating furnace and a soaking furnace at a first-half part of a continuous annealing facility for a steel sheet comprising a direct heating furnace, a soaking furnace and a cooling furnace. In FIG. 1, a steel sheet 1 is introduced from a left side of the figure to a heating furnace 2, heated to a soaking temperature as a target heating temperature (target soaking temperature) before it reaches an exit side of the heating furnace (point A in FIG. 1), introduced into a soaking furnace 3, kept at the soaking temperature for a given time, and then cooled. In the heating furnace 2, a furnace temperature setting value of the heating furnace 2 is calculated based on conditions of a material (steel sheet) to be treated (sheet thickness, sheet width, specific heat and so on) and annealing conditions (sheet threading speed, atmosphere gas, general heat transfer coefficient ∅_{CG} and so on) input in a host computer, whereby flow rates of fuel and air supplied to the heating furnace 2 are automatically controlled to achieve the furnace temperature setting value. In the soaking furnace 3, the furnace temperature is set to the soaking temperature as the target heating temperature of the steel sheet, and flow rates of fuel and air supplied to the soaking furnace 3 are automatically controlled to attain the furnace temperature setting value.

Moreover, there are various methods for determining the furnace temperature setting value of the heating furnace by the host computer. For example, the setting value can be determined by a convergent calculation using a heat transfer model equation as shown by the following equation (1):

ΔTₛΔX=2·∅_{CG}·σ(T_{f}⁴−Tₛ⁴)/Cₚ·ρ·D·Lₛ (1)

, wherein Tₛ is a sheet temperature at exit side (K), X is a heating length (m), ∅_{CG} is a general heat transfer coefficient (general heat absorption ratio), σ is the Stefan-Boltzmann constant (J/s·m²K⁴). T_{f} is a furnace temperature (K), Cₚ is a specific heat (J/kg·K), ρ is a specific gravity (kg/m³), D is a sheet thickness (mm), and Lₛ is a sheet threading speed (m/s).

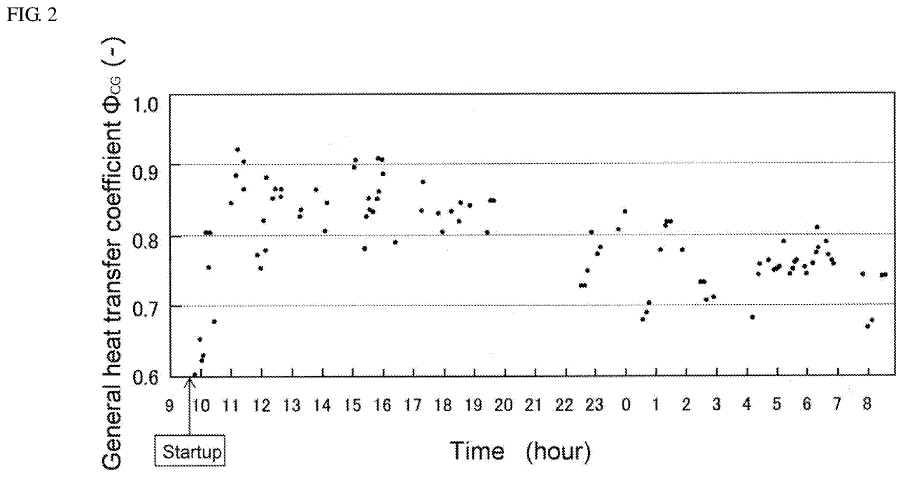

In the exit side of the heating furnace 2 (point A in FIG. 1), as described above, it is necessary that the temperature of the steel sheet (sheet temperature) is precisely heated to the soaking temperature as the target heating temperature. However, the conditions input to the host computer are not always constant and vary from hour to hour. Especially, in a heating furnace where the burner used for heating is not a radiant tube type but a direct type, a change of the general heat transfer coefficient ∅_{CG} with a lapse of time is large. FIG. 2 shows an example of actual measurement results of the general heat transfer coefficient ∅_{CG} during the period from the start-up of the furnace to the elapse of 24 hours when a hot-rolled steel sheet having a sheet width of 1052 to 1062 mm is subjected to a hot-band annealing at 1000° C. in a continuous annealing facility provided with a heating furnace using a direct-type burner. In such a continuous annealing facility where the general heat transfer coefficient ∅_{CG} largely varies, it is difficult to set the furnace temperature of the heating furnace with high precision, and hence it is impossible to control the sheet temperature at the exit side of the heating furnace (point A) to the given target soaking temperature.

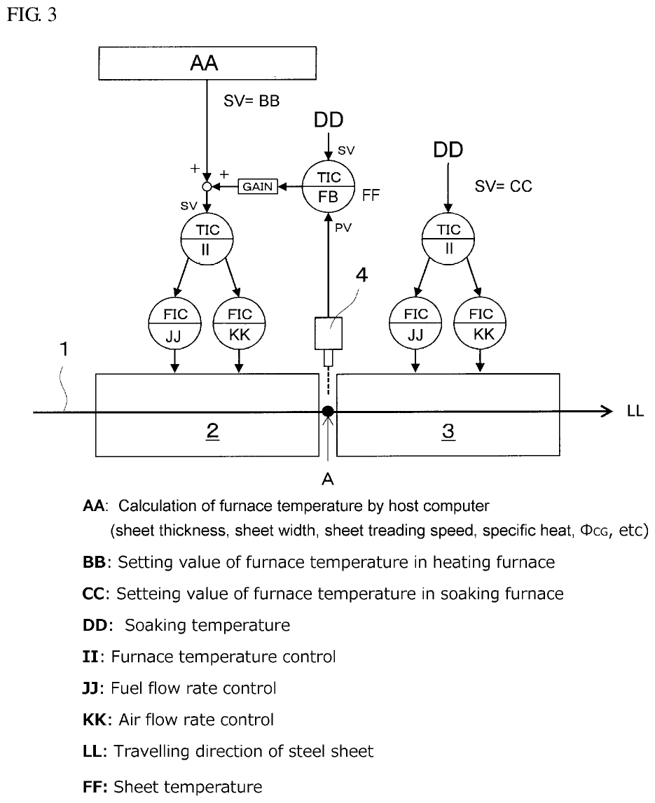

In order to solve the above problem, as shown in FIG. 3, the furnace temperature is adjusted by arranging a sheet temperature measuring gauge 4 at the point A of the exit side of the heating furnace to measure the sheet temperature at the exit side of the heating furnace, feedbacking the measurement result to a furnace temperature control system to control flow rates of fuel and air supplied to the heating furnace so as to render the sheet temperature at the point A of the exit side of the heating furnace into a soaking temperature as a target heating temperature. In FIG. 3, an actual measurement value PV of the sheet temperature at the point A of the exit side of the heating furnace measured by the sheet temperature measuring gauge 4 and the soaking temperature SV previously input as a target heating temperature are compared, and the setting temperature of the heating furnace is corrected in accordance with the difference between both values.

By adopting the control method of the steel sheet temperature shown in FIG. 3, the sheet temperature at the exit side of the heating furnace can be controlled to the soaking temperature as the target heating temperature with a variation range of ±α° C. However, there are problems as follows.
(1) It is difficult to control the furnace temperature with high precision, because the heat capacity of the heating furnace is very large and the change of the furnace temperature is slow by the feedback control mentioned above even when the gain is increased.

(2) The soaking temperature is desirable to be higher in order to improve the product properties, but the excessively high sheet temperature adversely affects the product properties. In the latter case, it is necessary to avoid such overheating that exceeds the target soaking temperature toward a plus side. Also, the heating exceeding the target soaking temperature is unfavorable from a viewpoint of heat energy.

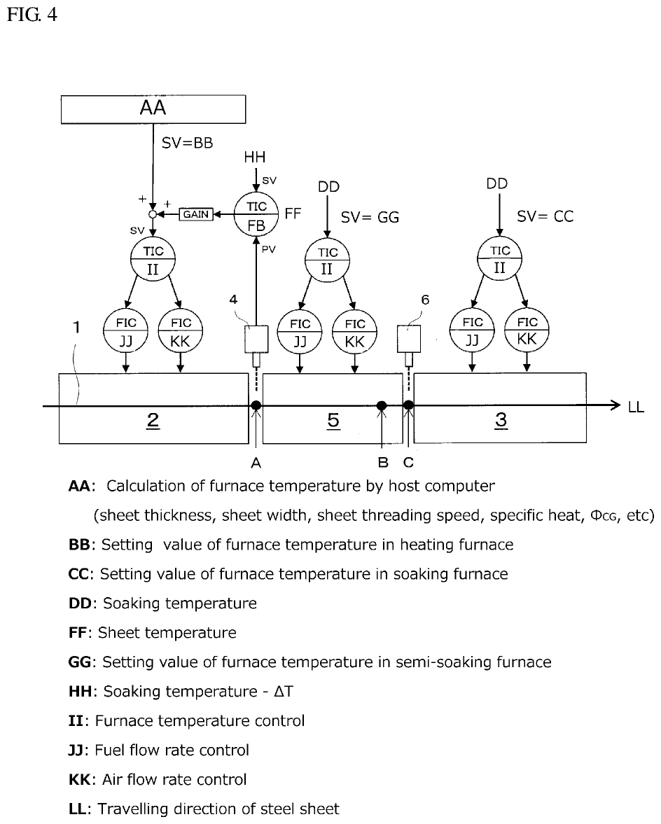

In order to deal with the above problems, as shown in FIG. 4, the invention proposes a method of heating a steel sheet where a semi-soaking furnace 5 is disposed between a heating furnace 2 and a soaking furnace 3; the steel sheet is heated in the heating furnace 2 so that the sheet temperature at the exit side of the heating furnace reaches (a soaking temperature-ΔT); the furnace temperature is set to the soaking temperature as a target heating temperature in the semi-soaking furnace 5; and the steel sheet is heated so as to reach the soaking temperature at a position before the exit side of the semi-soaking furnace 5, i.e. at a position in the semi-soaking furnace 5 (point B shown in FIG. 4).

Here, ΔT is necessary to be a value of not less than α, wherein ±α(° C.) is the variation range with respect to the average value of the steel sheet temperature at the exit side of the heating furnace when the furnace temperature is controlled by feedback control based on the sheet temperature measured at the exit side of the heating furnace (point A in FIG. 4). Here, α a is defined as a value of 3 times of a standard deviation a of the sheet temperature at the exit side of the heating furnace. When ΔT is less than α° C., there is a possibility that the steel sheet temperature may partially exceed the soaking temperature as a target heating temperature at the exit side of the heating furnace, when the steel sheet temperature unexpectedly increases in the feedback control of the furnace temperature in the heating furnace.

When the furnace temperature of the semi-soaking furnace is set to the soaking temperature as the target heating temperature, it is necessary that 2ΔT is not more than β, i.e., ΔT is not more than ½ of β, wherein a temperature increasing quantity of the steel sheet capable of being heated in the semi-soaking furnace, i.e. a heating capacity of the steel sheet in the semi-soaking furnace is β (° C.). When ΔT is more than β/2, there is a possibility that steel sheet cannot be partially heated to the soaking temperature as the target in the semi-soaking furnace, when the steel sheet temperature unexpectedly decreases in the feedback control of the furnace temperature in the heating furnace. Moreover, ΔT is preferably not more than 0.4 of β, more preferably not more than 0.3 of β. The steel sheet heating capacity β in the semi-soaking furnace can be determined by the above heat transfer model used when the furnace temperature is set for the heating furnace.

In the heating method according to the invention, the steel sheet can be heated to the target soaking temperature without being overheated, at a position before it arrives at the exit side of the semi-soaking furnace, and also heated uniformly in the sheet width direction. When ΔT is too small, even though it satisfies the above conditions, the sheet temperature reaches the target soaking temperature in the first half portion of the semi-soaking furnace to substantially bring about the prolongation of the soaking time. Therefore, when the acceptable range to the soaking time is severe, ΔT is preferably set so that the steel temperature can reach the soaking temperature at a position closest to the exit side of the semi-soaking furnace as much as possible. Concretely, although it depends on the length of the semi-soaking furnace, ΔT is preferably set so that the steel sheet temperature can reach the soaking temperature in the latter half range of the semi-soaking furnace, more preferably in the latter ⅓ range.

Also, the steel sheet heating capacity β of the semi-soaking furnace according to the invention is largely dependent on supply capacities of fuel and air supplied to the direct burner in the semi-soaking furnace, particularly a supply capacity (supply flow rate) of the fuel, and also has an influence on the setting value of ΔT. In the heating method of the steel sheet according to the invention, therefore, it is preferable that ΔT is set to a large value when the actual value of the flow rate of the fuel supplied to the direct burner in the semi-soaking furnace reaches the lower limit of the supply capacity (the fuel supply capacity is sufficient), while ΔT is set to a small value when it reaches the upper limit of the supply capacity (the fuel supply capacity is insufficient).

From the viewpoint that the steel sheet is stably heated to the target soaking temperature in the semi-soaking furnace, the upper limit of ΔT is preferably set according to the steel sheet heating capacity β within the range from the lower limit of supply capacity×1.2 to the upper limit of supply capacity ×0.8 of the flow rate of the fuel supplied to the direct burner in the semi-soaking furnace. More preferably, it is the range from the lower limit of supply capacity ×1.3 to the upper limit of supply capacity×0.7.

A sheet temperature measuring gauge 6 is disposed at the exit side of the semi-soaking furnace shown in FIG. 4 (point C shown in FIG. 4). The sheet temperature measuring gauge 6 measures the sheet temperature at the exit side of the semi-soaking furnace, and is not used in the feedback control of the furnace temperature in the semi-soaking furnace. It may be used in the feedback control as a matter of course. Also, it is preferable that the sheet temperature measuring gauge 6 at the point C can measure sheet temperatures in at least three points of widthwise central portion and both widthwise end portions of the steel sheet to calculate the temperature difference in the sheet width direction of the steel sheet.

### EXAMPLES

A hot-rolled steel sheet having a sheet thickness of 2.0 mm and a sheet width of 1100 mm is subjected to a heat treatment at a soaking temperature of 1000° C. in a continuous annealing facility, shown in FIG. 4, that is comprised of a direct heating furnace, a soaking furnace, and a cooling furnace and disposed with a direct semi-soaking furnace having a function according to the invention between the heating furnace and the soaking furnace. Moreover, the semi-soaking furnace is constructed by applying the function as the semi-soaking furnace according to the invention to the last half portion of the conventional heating furnace separated from the first half portion thereof, and is possible to be used as the conventional heating furnace when the semi-soaking function is necessary.

In this case, the heat treatment is conducted under two conditions when the function of the invention is developed by operating the semi-soaking furnace, that is, when the furnace temperature is set to the soaking temperature and the steel sheet temperature at the exit side of the heating furnace is set to (soaking temperature-ΔT) to control ΔT to an adequate range according to the invention (Invention Example), and when the semi-soaking furnace is stopped to operate and used in a part of the conventional heating furnace (Comparative Example), where sheet temperatures at three point of the widthwise central portion and both widthwise end portions of the steel sheet are continuously measured with a sheet temperature measuring gauge disposed in the exit side of the semi-soaking furnace (sheet temperature measuring gauge 6 shown in FIG. 4).

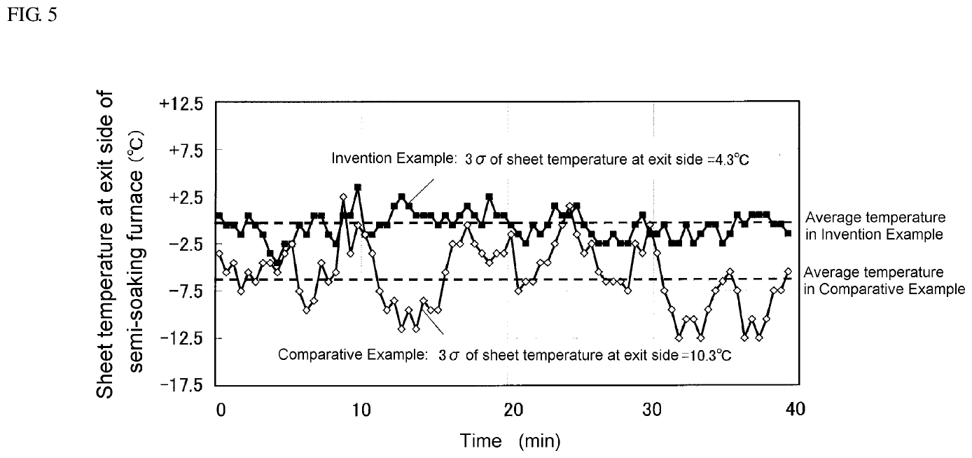

FIG. 5 shows a change of a temperature in the widthwise central portion of the hot-rolled steel sheet actually measured at the exit side of the semi-soaking furnace with a lapse of time, comparing the case with and without the operation of the semi-soaking furnace. Moreover, the temperature in the vertical axis of FIG. 5 is a temperature when an average value in Invention Examples is 0° C. As seen from this figure, the changing quantity of the temperature in the longitudinal direction of the steel sheet is reduced by not more than ½, from 3σ: 10.3° C. to 4.3° C., by disposing the semi-soaking furnace (wherein σ is a standard deviation). In the conventional technique, the value of ΔT at the exit side of the heating furnace is set to a larger value, with concern over overheating of the steel sheet. In Invention Example, there is found to be no concern in this regard as a result of the above, so that the value of ΔT can be made small, which enables the steel sheet to be heated to the soaking temperature promptly.

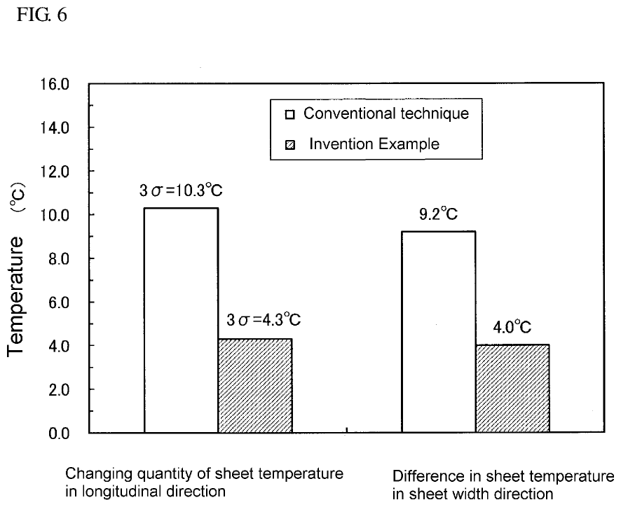

FIG. 6 shows a temperature difference in the sheet width direction of the steel sheet (difference between the highest temperature and the lowest temperature in the sheet width direction) in comparison between Invention Example and Comparative Example, in addition to the changing quantity of the temperature in the longitudinal direction of the steel sheet shown in FIG. 5. As seen from this figure, the temperature difference in the sheet width direction can be reduced by not more than ½, from 9.2° C. to 4.0° C., by adopting the semi-soaking furnace according to the invention.

### INDUSTRIAL APPLICABILITY

Moreover, the above description of the invention is explained on the premise that the semi-soaking furnace is a direct type. The semi-soaking furnace according to the invention is not limited to the direct type, and may be a radiant tube type from a viewpoint of increasing an accuracy in the control of the sheet temperature.

### REFERENCE SIGNS LIST

1: steel sheet (steel strip)

2: heating furnace

3: soaking furnace

4: sheet temperature measuring gauge

5: semi-soaking furnace

6: sheet temperature measuring gauge

1. A method of heating a steel sheet in a continuous annealing facility comprising a direct heating furnace, a soaking furnace and a cooling furnace, wherein
a direct semi-soaking furnace is disposed between the heating furnace and the soaking furnace;
the steel sheet is heated in the heating furnace so that a steel sheet temperature at an exit side of the heating furnace reaches (a target soaking temperature-ΔT); and
a furnace temperature in the semi-soaking furnace is set to the target soaking temperature of the steel sheet and the steel sheet is heated so that the steel sheet temperature reaches the target soaking temperature at a position in the semi-soaking furnace,
wherein ΔT is a value of not less than the variation range of the steel sheet temperature when the sheet temperature is controlled by feedback control in the heating furnace, and is a value of not more than ½ of the heating capacity for the steel sheet in the semi-soaking furnace.

2. The method of heating a steel sheet according to claim 1, wherein the value of ΔT is made large when a flow rate of a fuel supplied to a direct burner in the semi-soaking furnace reaches the lower limit of a fuel supply capacity in the semi-soaking furnace, while the value of ΔT is made small when it reaches the upper limit of the fuel supply capacity in the semi-soaking furnace.

3. The method of heating a steel sheet according to claim 1,
wherein the flow rate of the fuel supplied to the direct burner in the semi-soaking furnace falls within the range from the lower limit of the fuel supply capacity×1.2 to the upper limit of the fuel supply capacity×0.8 in the semi-soaking furnace.

4. A continuous annealing facility for a steel sheet comprising a direct heating furnace, a soaking furnace and a cooling furnace,
wherein
a direct semi-soaking furnace is disposed between the heating furnace and the soaking furnace;
the steel sheet is heated in the heating furnace so that a steel sheet temperature at an exit side of the heating furnace reaches (a target soaking temperature-ΔT); and
the furnace temperature in the semi-soaking furnace is set to the target soaking temperature of the steel sheet and the steel sheet is heated so that the temperature thereof reaches the target soaking temperature at a position of the semi-soaking furnace,
wherein ΔT is a value of not less than the variation range of the steel sheet temperature when the sheet temperature is controlled by feedback control in the heating furnace, and is a value of not more than ½ of the heating capacity for the steel sheet in the semi-soaking furnace.

5. The method of heating a steel sheet according to claim 2,
wherein the flow rate of the fuel supplied to the direct burner in the semi-soaking furnace falls within the range from the lower limit of the fuel supply capacity×1.2 to the upper limit of the fuel supply capacity>0.8 in the semi-soaking furnace.
